(19) United States
(12) Patent Application Publication
(10) Pub. No.: US 2004/0251367 A1
(43) Pub. Date: Dec. 16, 2004

(54) Seat belt device

(75) Inventors: Yoshitaka Suzuki, Wako-Shi (JP); Hiroshi Akaba, Wako-Shi (JP); Hiroshi Iwami, Wako-Shi (JP); Nobuhiro Koyota, Wako-Shi (JP)

Correspondence Address: MERCHANT & GOULD PC, P.O. BOX 2903, MINNEAPOLIS, MN, 55402-0903, US

(73) Assignee: HONDA MOTOR CO., LTD., MINATO-KU (JP)

(21) Appl. No.: 10/789,894

(22) Filed: Feb. 27, 2004

(30) Foreign Application Priority Data
Mar. 6, 2003 (JP) 2003-59651

(51) Int. Cl. B60R 22/46; B60R 22/40

(52) U.S. Cl. 242/390.8; 280/806

(57) ABSTRACT

In a seat belt device, when the collision of a vehicle is foreknown, a motor of a retractor is driven for rotation in a normal direction to take up a webbing of a seat belt, and when an acceleration equal to or larger than a predetermined value is applied to the vehicle, the webbing is locked so that it cannot be drawn out of the retractor. In a case where the collision is avoided after the motor of the retractor is driven for rotation in the normal direction based on the foreknowing of the collision to increase the tension of the webbing of the seat belt, when it is detected by systems having information regarding the acceleration of the vehicle that the acceleration of the vehicle has been reduced to be smaller than the predetermined value, the locking operation of the retractor is cancelled to loose the webbing by driving the motor of the retractor for rotation in the normal direction. Thus, it is possible to draw out the webbing by a motor-assisted pretensioner of the seat belt device with a good timing without need for a special sensor and an actuator.

### BACKGROUND OF THE INVENTION

1. Field of the Invention

The present invention relates to a seat belt device in which when a collision of a vehicle is foreknown, a motor of a retractor is driven for rotation in a normal direction to take up a webbing of a seat belt, and when an acceleration equal to or larger than a predetermined value is applied to the vehicle, the webbing is locked so that it cannot be drawn out of the retractor.

2. Description of the Related Art

Japanese Patent Application Laid-open No. 2000-211474 discloses a so-called emergency locking retractor which is adapted to lock a webbing of a seat belt device so that it cannot be drawn out from the retractor, when an acceleration equal to or larger than a predetermined value is applied to a vehicle. In such an emergency locking retractor, a ratchet claw capable of being engaged with a ratchet tooth of an inertia gear mounted on a webbing take-up shaft is connected to an upper end of a weight swingably supported on a weight seat of a sensor case, so that when an acceleration equal to or larger than a predetermined value (e.g., 0.4 G) is applied to a vehicle, whereby the weight is inclined, the ratchet claw is pushed up and brought into engagement with the ratchet tooth of the inertia gear, whereby a webbing is locked so that it cannot be drawn out from the retractor.

Japanese Patent No. 2946995 discloses a motor-assisted pretensioner which is designed so that when the collision of a vehicle is foreknown, a webbing take-up shaft of a retractor of a seat belt device is driven by a motor to take up a webbing, thereby increasing the tension of the webbing to enhance an occupant-restraining performance upon the collision.

In a case where the motor-assisted pretensioner is combined with the emergency locking retractor, when the collision of the vehicle is avoided after the motor-assisted pretensioner has increased the tension of the webbing to restrain an occupant based on the foreknowing of the collision of the vehicle, it is necessary to loosen the tension of the webbing again to cancel the restraint of the occupant. In this case, the occupant is in a restrained state and hence, the engagement of the ratchet tooth and the ratchet claw with each other is maintained, whereby the emergency locking retractor remains in a locking state and hence, the webbing cannot be drawn out by the motor-assisted pretensioner. To avoid this situation, a sensor for detecting the inclination of the weight of the emergency locking retractor is mounted, and after it detects that the inclination has been eliminated to provide a state in which the locking state of the retractor of the emergency locking retractor can be released, an actuator is required to forcibly release the engagement of the ratchet tooth and the ratchet claw. However, such an arrangement suffers from a problem of an increase in the number of parts, because of the needs for the sensor for detecting the inclination of the weight and the actuator for releasing the engagement of the ratchet tooth and the ratchet claw.

### SUMMARY OF THE INVENTION

Accordingly, it is an object of the present invention to ensure that the drawing-out of the webbing by the motor-assisted pretensioner of the seat belt device can be carried out with a good timing without need for a special sensor and an actuator.

To achieve the above object, according to a first aspect and feature of the present invention, there is provided a seat belt device in which when a collision of a vehicle is foreknown, a motor of a retractor is driven for rotation in a normal direction to take up a webbing of a seat belt, and when an acceleration equal to or larger than a predetermined value is applied to the vehicle, the webbing is locked so that it cannot be drawn out of the retractor, wherein when the collision of the vehicle has been avoided, and it is detected by systems having information regarding the acceleration of the vehicle that the acceleration of the vehicle has been reduced to be smaller than the predetermined value, the motor of the retractor is driven for rotation in the normal direction to cancel the locking, thereby loosening the webbing.

With the above arrangement, if the collision of the vehicle is avoided after the motor of the retractor is driven for rotation in the normal direction based on the foreknowing of the collision of the vehicle to take up the webbing of the seat belt, when it is detected by the systems having information regarding the acceleration of the vehicle that the acceleration of the vehicle has been reduced to be smaller than the predetermined value, the locking operation of the retractor is cancelled to loose the webbing. Therefore, it is possible to previously avoid a situation in which the webbing cannot be loosened by driving the motor of the retractor for rotation in a reverse direction in a state in which the webbing has been locked so that it cannot be drawn out of the retractor without need for a special actuator for canceling the locking operation. In addition, a signal of the acceleration of the vehicle from the system having the information regarding the acceleration of the vehicle is utilized and hence, a special sensor for detecting whether or not the webbing is in a state in which it has been locked so that it cannot be drawn out of the retractor is not required. This can contribute to a reduction in the number of parts.

The above and other objects, features and advantages of the invention will become apparent from the following description of the preferred embodiment taken in conjunction with the accompanying drawings.

### BRIEF DESCRIPTION OF THE DRAWINGS

FIG. 1 is a block diagram of a control system for a seat belt device according to an embodiment of the present invention.

FIG. 2 is a view showing the structure of a retractor.

FIG. 3 is an enlarged view of essential portions of FIG. 2.

### DESCRIPTION OF THE PREFERRED EMBODIMENT

The present invention will now be described by way of a preferred embodiment with reference to the accompanying drawings.

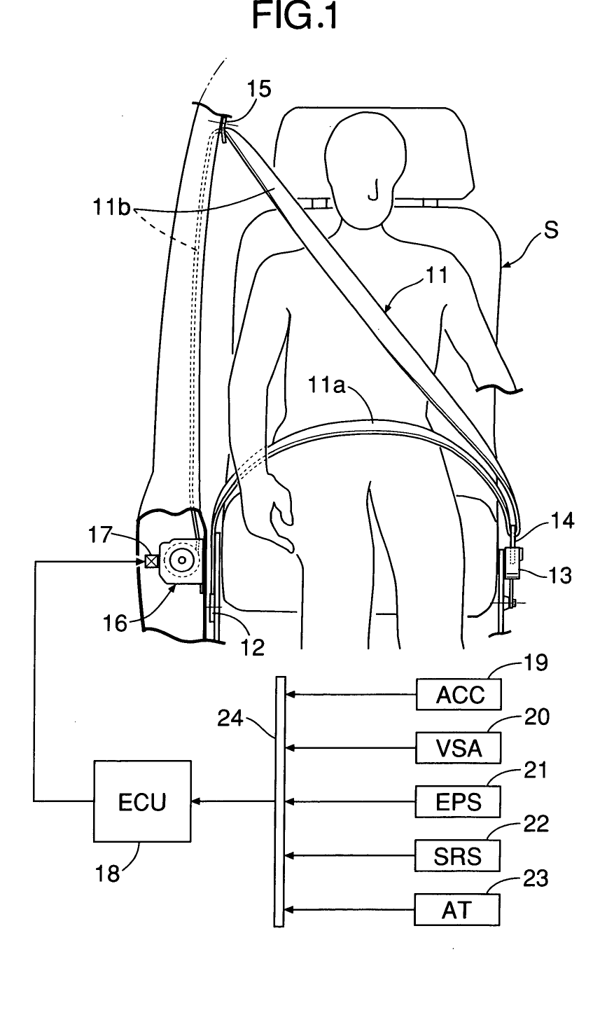

Referring first to FIG. 1, a webbing 11 of a seat belt device for restricting an occupant sitting on a seat S of an automobile includes a lap belt 11a and a shoulder belt 11b integrally connected to each other. The lap belt 11a fixed at one end to an anchor 12 is adapted to extend over an abdomen of the occupant, and to be connected at the other end to one end of the shoulder belt 11b through a tongue 14 which is adapted to be disengageably engaged with a buckle 13. The shoulder belt 11b is adapted to extend obliquely over a breast of the occupant and through a through-anchor 15 and then downwards and to be taken up in a retractor 16.

The retractor 16 is provided with a motor 17 for taking up the webbing 11 and drawing out the webbing 11 to adjust the tension of the webbing 11. An ACC system 19, a VSA system 20, an EPS system 21, an SRS 22, an automatic transmission (AT) 23 and the like are connected through an internal LAN 24 to an electronic control unit 18 for controlling the operation of the motor 17.

The ACC (adaptive cruise control) system 19 is adapted to control the vehicle speed of a subject vehicle so as to maintain a distance between the subject vehicle and a preceding vehicle at a preset vehicle-vehicle distance, when the preceding vehicle has been detected by a radar device, and to allow the subject vehicle to travel at a constant speed corresponding to a preset vehicle speed, when no preceding vehicle exists. Therefore, it is possible to calculate a longitudinal acceleration from the vehicle speed to utilize the longitudinal acceleration.

The VSA (vehicle stability assisting) system 20 is adapted to calculate a target yaw rate from a steering angle of a steering wheel and the vehicle speed, and to control braking forces for left and right wheels individually so that an actual yaw rate is equal to the target yaw rate, thereby enhancing the stability of the vehicle during turning of the vehicle. Therefore, it is possible to calculate a lateral acceleration from the steering angle and the vehicle speed to utilize the lateral acceleration.

The EPS (electric power steering) system 21 is adapted to detect a steering torque input to the steering wheel, and to drive an assisting motor so that the steering torque assumes a predetermined value depending on the vehicle speed and the like, thereby assisting in a steering operation conducted by a driver. Therefore, it is possible to calculate a lateral acceleration from the steering angle and the vehicle speed to utilize it, as does the VSA system.

The SRS (supplementary restraint system) 22 is adapted to deploy an air bag based on an acceleration detected by an acceleration sensor upon collision of the vehicle, and the acceleration detected by the acceleration sensor can be utilized as it is.

The ACC system 19, the VSA system 20, the EPS system 21, the SRS 22, the automatic transmission 23 and the like use a signal of the longitudinal acceleration of the vehicle or the lateral acceleration of the vehicle, and correspond to systems having information regarding accelerations of the vehicle in accordance with the present invention.

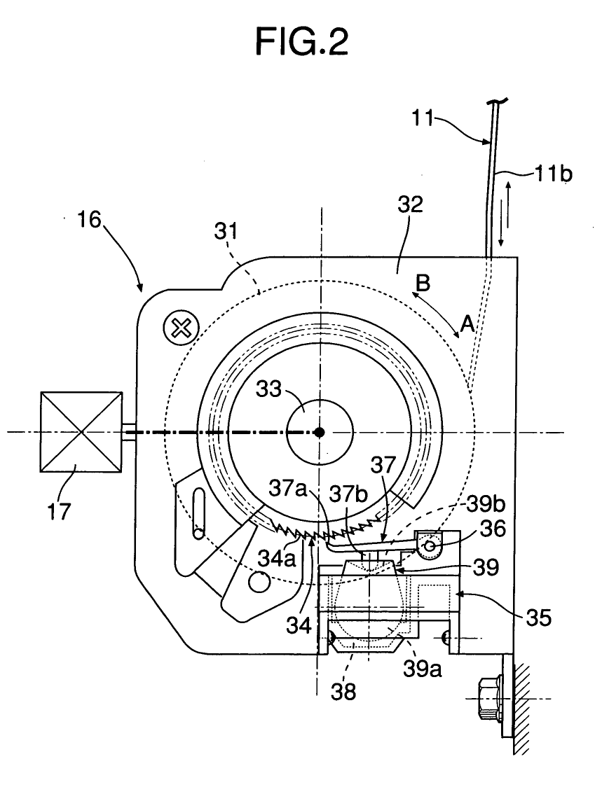

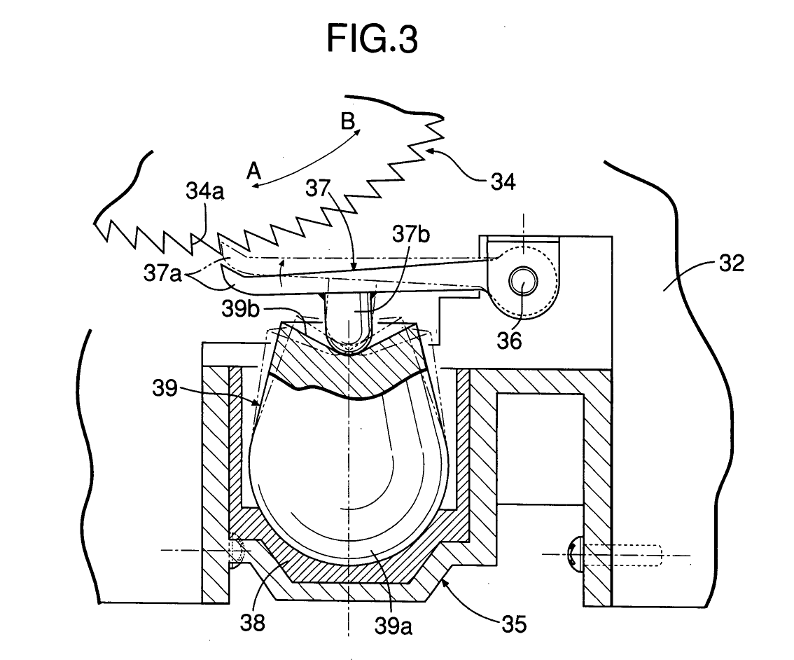

FIGS. 2 and 3 show the structure of the retractor 16. An inertia gear 34 is mounted at an end of a rotary shaft 33 which rotatably supports a reel 31 for taking up the shoulder belt 11b of the webbing 11 in a casing 32, so that inertia gear 34 is exposed to the outside of the casing 32. A large number of ratchet teeth 34a are provided around an outer periphery of the inertia gear 34, and a ratchet claw 37a capable of being engaged with the ratchet tooth 34a of the inertia gear 34 is mounted at a tip end of a locking lever 37 pivotally supported through a pivot 36 at an upper portion of a weight housing 35 mounted at a lower portion of the casing 32.

A weight 39 is swingably supported at its semi-spherical bottom 39a on a cup-shaped weight seat 38 mounted on a bottom of the weight housing 35, and a projection 37b provided on a lower surface of the locking lever 37 is engaged in an inversed conical recess 39a formed in a top surface of the weight 39.

The motor 17 is connected to the rotary shaft 33 of the reel 31, and is rotatable in both of a normal direction (a direction indicated by an arrow A) to take up the webbing 11 and a reverse direction (a direction indicated by an arrow B) to draw out the webbing 11, by a command from the electronic control unit 18. The rotary shaft 33 of the reel 31 is biased in the direction to take up the webbing 11 by a spring which is not shown.

The operation of the embodiment of the present invention having the above-described arrangement will be described below.

When the acceleration applied to the vehicle is smaller (e.g., smaller than 0.4 G), the weight 39 of the retractor 16 is an upright attitude and hence, the locking lever 37 is in a lowered position in which the ratchet claw 37a is away from the ratchet teeth 34a of the inertia gear 34, so that the rotary shaft 33 of the reel 31 can be rotated freely. Therefore, when an occupant sitting on the seat S and having the seat belt put around him moves his body, the webbing 11 can be drawn out of the retractor 16 and taken up in the retractor 16 by the spring (not shown) in accordance with such movement of the body, whereby the restraint of the occupant's body is canceled.

When the driver performs a sudden braking or operates the steering wheel rapidly in order to avoid a danger, the weight 39 is inclined from the upright attitude due to the longitudinal or lateral acceleration applied to the vehicle. For this reason, the locking lever 37 having the projection 37b urged into the recess 39b in the weight 39 is swung upwards about the pivot 36, whereby the ratchet claw 37a of the locking lever 37 is brought into engagement with the ratchet tooth 34a of the inertia gear 34 to lock the inertia gear 34 (namely, the reel 31) non-rotatably, so that the webbing 11 cannot be drawn out. As a result, the reel 31 of the retractor 16 is locked non-rotatably in the drawing-out direction (the direction indicated by the arrow B) and thus, the webbing 11 becomes incapable of being loosened to restrain the occupant.

Even if the webbing 11 is incapable of being loosened from the retractor 16, when the tension of the webbing at that time is insufficient, it cannot exhibit a sufficient occupant-restraining performance. Therefore, when the collision of the vehicle is foreknown, the motor 17 is rotated in the normal direction by the command from the electronic control unit 18 to rotate the reel 31 in the direction indicated by the arrow A, whereby the webbing 11 is drawn into the retractor 16 to generate a predetermined tension for restraining the occupant. Even if the ratchet claw 37a of the locking lever 37 has been already brought into engagement with the ratchet tooth 34a of the inertia gear 34 by the acceleration of the vehicle at that time, the motor 17 can be rotated in the normal direction without hindrance to increase the tension of the webbing 11, because the rotation of the inertia gear 34 in the direction indicated by the arrow A is in a direction in which the ratchet claw 37a and the ratchet teeth 34a slip relative to each other.

The foreknowing of the collision of the vehicle by the electronic control unit 18 may be carried out based on signals from the ACC system 19, the VSA system 20, the EPS system 21 and the like, or may be carried out based on an acceleration from an exclusive collision foreknowing device. When the collision of the vehicle has occurred actually, the tension of the webbing 11 may be further increased by a tensioner device using an explosive powder in order to further enhance the occupant-restraining performance provided by the seat belt. Usually, the restraint of the occupant based on the foreknowing of the collision precedes a collision-avoiding operation.

Now, when the collision has been avoided by an avoiding operation, the electronic control unit 18 rotates the motor 17 in the normal direction to rotate the reel 31 and the inertia gear in an amount corresponding to one crest of the ratchet teeth in the direction indicated by the arrow A, after it is confirmed that the acceleration of the vehicle has been reduced to lower than the predetermined value (e.g., 0.4 G), based on a signal from the ACC system 19, the VSA system 20, the EPS system 21, the SRS 22, the automatic transmission 23 or the like for controlling the acceleration of the vehicle, namely, after it is confirmed that the weight 39 has been restored to the upright attitude, whereby the locking of the inertia gear 64 has been canceled. As a result, the locking lever 37 is dropped by the force of gravity, thereby causing the ratchet claw 37a to be disengaged from the ratchet tooth 34a. Therefore, the inertia gear 34 is unlocked rotatably in the direction indicated by the arrow B and thus, the tension of the webbing 11 can be reduced to release the restraint of the occupant.

In this way, the motor 17 of the retractor 16 is driven for rotation in the normal direction based on the acceleration signal from the existing system without provision of a special sensor for detecting that the weight 39 has been restored to the upright attitude. Therefore, a special sensor or an unlocking actuator are not required, leading to a reduction in the number of parts, which can contribute to a reduction in cost.

Although the embodiment of the present invention has been described in detail, it will be understood that the present invention is not limited to the above-described embodiment, and various modifications in design may be made without departing from the subject matter of the invention defined in the claims.

For example, the system having the information regarding the acceleration of the vehicle is not limited to the ACC system 19, the VSA system 20, the EPS system 21, SRS 22 and the automatic transmission 23.

What is claimed is:

1. A seat belt device in which when a collision of a vehicle is foreknown, a motor of a retractor is driven for rotation in a normal direction to take up a webbing of a seat belt, and when an acceleration equal to or larger than a predetermined value is applied to the vehicle, the webbing is locked so that it cannot be drawn out of the retractor,
wherein when the collision of the vehicle has been avoided, and it is detected by systems having information regarding the acceleration of the vehicle that the acceleration of the vehicle has been reduced to be smaller than the predetermined value, the motor of the retractor is driven for rotation in the normal direction to cancel the locking, thereby loosening the webbing.
